(19) United States
(12) Patent Application Publication
(10) Pub. No.: US 2017/0182714 A1
(43) Pub. Date: Jun. 29, 2017

(54) SHAPING APPARATUS AND SHAPING METHOD

(71) Applicant: CANON KABUSHIKI KAISHA, Tokyo (JP)

(72) Inventor: Shigehiko Sato, Tachikawa-shi (JP)

(21) Appl. No.: 15/373,778

(22) Filed: Dec. 9, 2016

(30) Foreign Application Priority Data
Dec. 24, 2015 (JP) 2015-251464

(51) Int. Cl. B29C 67/00; B33Y 30/00; B33Y 50/02; B33Y 10/00

(52) U.S. Cl. CPC B29C 67/0088; B33Y 10/00; B33Y 30/00; B33Y 50/02; B29K 2101/12

(57) ABSTRACT

A shaping apparatus including a data generation unit that generates slice data on each layer, based on given shape data, and shaping a solid object by sequentially stacking material layers formed of a shaping material, based on the slice data, the shaping apparatus includes an acquisition unit that acquires information on a height of the material layer in a stacking direction during shaping; and a control unit that allows the data generation unit to regenerate the slice data for forming the material layer necessary for completing a solid object, which is being shaped, based on an acquisition result obtained by the acquisition unit.

### BACKGROUND OF THE INVENTION

Field of the Invention

The present invention relates to a shaping apparatus and a shaping method.

Description of the Related Art

Conventionally, various methods, called additive manufacturing (AM), for manufacturing a three-dimensional solid object by sequentially stacking layers corresponding to cross-sections (slices) obtained by cutting a three-dimensional model along parallel planes are known. For example, Japanese Patent Application Publication No. 2002-347129 proposes a stacking and shaping method of forming electrostatic powder in a solid cross-sectional shape, heating, pressing, and stacking the solid powder to manufacture a solid object. However, this method has a problem that the height of the solid object becomes smaller than an expected size due to pressing and thermal shrinkage. On the other hand, a method of comparing a theoretical value and an actual measurement value and increasing or decreasing a stacking sheet (a material layer) based on a comparison result to adjust the height is proposed as a method for correcting a shaping height (Japanese Patent Application Publication No. 2010-240843).

### SUMMARY OF THE INVENTION

However, the following problems may occur in the conventional technique described above. In a method of compensating for the height reduced due to pressing and a temperature change during shaping by sequentially adding a sheet, a strain may occur in a horizontal direction of a shaping object, which may result in a tapered shape in relation to a target shaping model.

With the foregoing in view, an object of the present invention is to correct the height of a solid object while suppressing a decrease in the accuracy in a horizontal direction.

The present invention in its first aspect provides a shaping apparatus including a data generation unit that generates slice data on each layer, based on given shape data, and shaping a solid object by sequentially stacking material layers formed of a shaping material, based on the slice data, the shaping apparatus comprising: an acquisition unit that acquires information on a height of the material layer in a stacking direction during shaping; and a control unit that allows the data generation unit to regenerate the slice data for forming the material layer necessary for completing a solid object, which is being shaped, based on an acquisition result obtained by the acquisition unit.

The present invention in its second aspect provides a shaping method of using a shaping apparatus including a data generation unit that generates slice data on each layer, based on given shape data, and shaping a three-dimensional solid object by sequentially stacking material layers formed of a shaping material, based on the slice data, the shaping method comprising: operating an acquisition unit to acquire information on a height of the material layer in a stacking direction during shaping; and operating the data generation unit to regenerate the slice data for forming the material layer necessary for completing a solid object, which is being shaped, based on an acquisition result obtained by the acquisition unit.

The present invention in its third aspect provides a non-transitory computer readable storing medium recording a computer program for allowing a computer to execute steps of a shaping method of using a shaping apparatus including a data generation unit that generates slice data on each layer, based on given shape data, and shaping a solid object by sequentially stacking material layers formed of a shaping material, based on the slice data, the steps including: operating an acquisition unit to acquire information on a height of the material layer in a stacking direction during shaping; and operating the data generation unit to regenerate the slice data for forming the material layer necessary for completing a solid object, which is being shaped, based on an acquisition result obtained by the acquisition unit.

According to the present invention, it is possible to correct the height of a solid object while suppressing a decrease in the accuracy in a horizontal direction.

Further features of the present invention will become apparent from the following description of exemplary embodiments with reference to the attached drawings.

### BRIEF DESCRIPTION OF THE DRAWINGS

FIG. 1 is a diagram for describing a stacking step of a shaping apparatus according to Embodiment 1;

FIG. 2 is a block diagram of functions of a control unit of Embodiment 1;

FIG. 3 is a flowchart illustrating a stacking and shaping process of Embodiment 1; and

FIG. 4 is a flowchart illustrating a slice data reconstruction process of Embodiment 2.

### DESCRIPTION OF THE EMBODIMENTS

A mode for implementing the present invention will now be exemplarily described with reference to the drawings. It is to be understood that procedures, control parameters, target values, and the like of various types of control including dimensions, materials, shapes, relative arrangements, and the like of respective members described in the following embodiment are not intended to limit the scope of the present invention to the embodiment described below unless specifically stated otherwise.

The present invention relates to a shaping apparatus employing an AM technology, that is, a technology for manufacturing a three-dimensional solid object (shaping object) by stacking thin layers on which shaping materials are two-dimensionally arranged or thin films obtained by melting the shaping materials.

As the shaping material, it is possible to select various materials in accordance with the use, function, and purpose of a solid object to be fabricated. In the present specification, a material constituting a three-dimensional object as a shaping target is referred to as “a build material”. A portion formed of the build material may be referred to as a build body hereinafter. A material constituting a support body for supporting the build body in the process of fabrication (e.g., build supporting an overhang portion from below) is referred to as “a support material”. In addition, in the case where it is not necessary to distinguish between them, a term “shaping material” is simply used. As the build material, it is possible to use thermoplastic resins such as, e.g., polyethylene (PE), polypropylene (PP), ABS, and polystyrene (PS). Further, as the support material, in order to facilitate removal from the build body, it is possible to use a material having thermoplasticity and water solubility preferably. Examples of the support material include carbohydrate, polylactic acid (PLA), polyvinyl alcohol (PVA), and polyethylene glycol (PEG).

In the present specification, digital data used for forming an image corresponding to one layer is referred to as “slice data”. Moreover, an image corresponding to one layer formed of a shaping material based on slice data is referred to as a “material layer”. Furthermore, a target build body that is to be manufactured using a shaping apparatus (that is, an object represented by shape data (image data, three-dimensional shape data) given to the shaping apparatus) is referred to as a “shaping target object”, and an object (a solid object) manufactured (output) by the shaping apparatus is referred to as “a shaping object”. When the shaping object includes a support body, a build body which is a portion obtained by excluding the support body corresponds to a solid object of the shaping target object.

### Embodiment 1

Hereinafter, Embodiment 1 will be described.

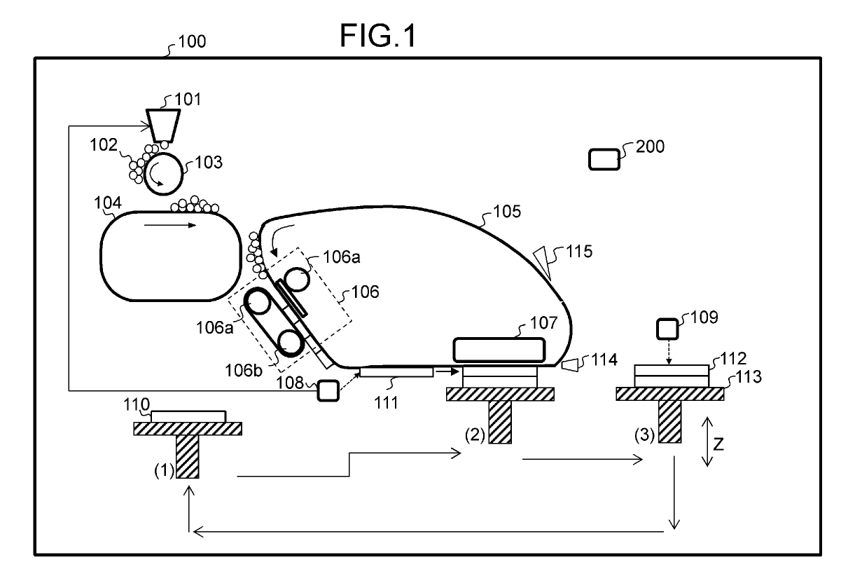

FIG. 1 is a schematic diagram illustrating an embodiment of a shaping apparatus according to the present invention and is a diagram for describing a stacking step. Hereinafter, a stacking step of the present embodiment will be described. Here, in the following description of the present embodiment, a direction indicated by arrow Z illustrated in FIG. 1 (an up-down direction when FIG. 1 is seen at a positive direction) is defined as a stacking direction in which a material layer is stacked, and a left-right direction when FIG. 1 is seen at a positive direction is defined as a horizontal direction (the direction orthogonal to the stacking direction).

A shaping apparatus 100 of the present embodiment performs a stacking and shaping process using the following configurations.

First, a shaping material 102 is supplied from a shaping material supply unit 101 by an electrophotographic process. The shaping material 102 is manufactured by grinding a thermoplastic resin material and has an electrostatic property.

The shaping material 102 is developed on a photosensitive drum 103 and is then transferred to a conveying member 104. The conveying member 104 and the intermediate transfer member 105 are coupled to start a synchronization operation to transfer the shaping material 102 to a predetermined position of the intermediate transfer member 105. The synchronization operation can be performed using a signal obtained by a sensor detecting a mark transferred simultaneously with the shaping material 102 as a trigger. Moreover, synchronization may be realized by measuring a conveying speed and a moving distance of the conveying member 104 and the intermediate transfer member 105 to synchronize the conveying member 104 and the intermediate transfer member 105.

When the shaping material 102 is transferred to the intermediate transfer member 105, the conveying member 104 and the intermediate transfer member 105 are separated to perform independent operations. The shaping material 102 transferred to the intermediate transfer member 105 is heated, melted, and pressed when passing through a heat roll 106 to become a sheet-shaped material layer 111, which is then conveyed toward a stacking position.

Here, the stacking position is a position at which the material layer 111 is stacked (on a shaping object being stacked), and in the configuration of FIG. 1, a portion of the intermediate transfer member 105 sandwiched between a heater 107 and a stage 113 corresponds to the stacking position.

A material thickness sensor 108 measures the thickness of the material layer 111. Based on the measurement result obtained by the material thickness sensor 108, a flow rate of the shaping material supplied from the shaping material supply unit 101, for example, is increased or decreased whereby the amount of the shaping material can be controlled. A slow cooler 114 makes the shaping object easily separated from the intermediate transfer member 105 after stacking. A collection blade 115 separates the shaping material remaining on the intermediate transfer member 105 from the intermediate transfer member 105 and collects the shaping material.

A stacking thickness sensor 109 measures the thickness of the material layer (when a first layer is stacked) or a shaping object (when a second layer or later is stacked) stacked on the stage 113. Based on the measurement result obtained by the stacking thickness sensor 109, the amount of the shaping material supplied from the shaping material supply unit 101 can be controlled.

FIG. 1 illustrates three states of the staking step, which transition from State (1) to State (2) and finally to State (3). In State (1), the material layer 110 of the first layer is on the stage 113 and a standby is performed until the material layer 111 of the second layer is stacked. State (2) indicates a state in which the material layer 111 on the intermediate transfer member 105 and the material layer 110 of the first layer on the stage 113 are melted and bonded by the heating of the heater 107 at the stacking position. In this case, based on the measurement result obtained by the material thickness sensor 108, the stage 113 is moved so that a bonding surface of the material layer 111 on the intermediate transfer member 105 coincides with a bonding surface of the material layer 110 on the stage 113.

The heat roll 106 includes two heaters 106a and a roller 106b and a gap having a predetermined height for allowing the shaping material 102 to pass therethrough is formed. The shaping material 102 is rolled by moving through this gap to become the sheet-shaped material layer 111.

The heater 107 may be configured to be able to press and heat the shaping material 102 as necessary and a planar heater, for example, is preferred. A ceramic heater, an induction heating (IH) heater, or the like can be used as an example of the heater 107. Here, means for pressing the shaping material 102 is not particularly limited and the means may be provided separately from the heater. For example, a rigid member may be used for the intermediate transfer member 105 so that the intermediate transfer member 105 can press the shaping material 102. Moreover, a rigid member may be fixedly disposed between the intermediate transfer member 105 and the heater 107 so that the rigid member can press the shaping material 102.

State (3) indicates a state in which the stacking thickness sensor 109 measures a displacement amount in the stacking direction (the direction indicated by arrow Z) of the surface of the shaping object 112 on the stage 113. In this state, it is possible to calculate a change in thickness of the shaping object 112 due to expansion and contraction of the material occurring when the state transitions from a heating state to a non-heating state. A diffuse reflection-type displacement sensor can be used as an example of the material thickness sensor 108 and the stacking thickness sensor 109, and an arbitrary device capable of measuring the thickness or the height of a target object may be used.

In the staking step, States (1), (2), and (3) are repeated whereby a desired shaping object is formed.

The stage 113 is not limited to moving in synchronization with the movement of the intermediate transfer member 105 as described above, and the stage 113 may move in a direction of coming into contact with or moving away from (in the present embodiment, the direction indicated by arrow Z) the heater 107. In this case, the movement of the intermediate transfer member 105 is stopped, and the material layer on the intermediate transfer member 105 is stacked on the stage 113. From the throughput's perspective, as in the present embodiment, it is preferable to move the stage 113 in synchronization with movement of the intermediate transfer member 105 without stopping the intermediate transfer member 105.

The shaping apparatus 100 may sequentially stack a material layer on the stage with the material interposed between the stage 113 and the heater 107 and the stage 113 and the heater 107 may be configured so that relative positions thereof can be changed. That is, the stage 113 may move in relation to the heater 107.

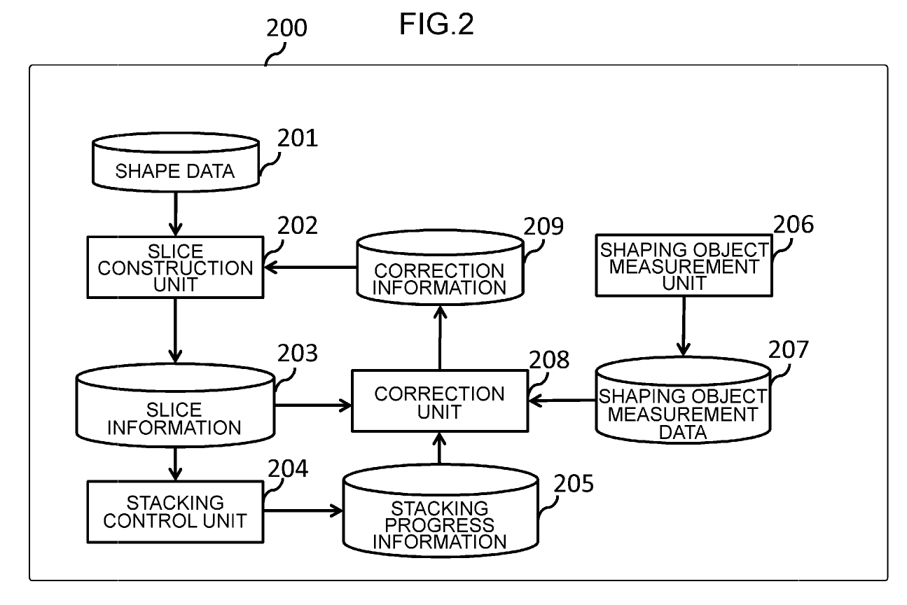

The shaping apparatus 100 includes a control unit 200 that controls the operation of the apparatus. The control unit 200 is a computer that includes a CPU (a processor), a ROM, a RAM, and the like, for example. FIG. 2 illustrates a block diagram of the functions of the control unit 200 of the present embodiment. The functions illustrated in FIG. 2 are realized when the CPU executes a program stored in the ROM or the like.

The shaping apparatus 100 is an apparatus that receives shape data 201 of a shaping target object as an input and manufactures a shaping object using a stacking and shaping method. The shape data 201 includes data related to a three-dimensional shape of a shaping target object and may further include color information, material information, and the like. The data related to a three-dimensional shape indicates data indicating a shaping model shape of a format such as standard triangulated language (STL), for example, and the format thereof is arbitrary.

A slice construction unit 202 is a processing unit that reads the shape data 201 and generates slice information 203. Here, the slice construction unit 202 corresponds to a data generation unit. The slice information includes slice data generated for each layer and setting information during slicing. Here, more specifically, the “slice data” is image data corresponding to one layer obtained by slicing a shaping object to be manufactured in a stacking direction at a predetermined interval.

Slice data is generated based on setting information defined by the shaping apparatus 100 or user's setting information. Here, the setting information includes the thickness, color information, material information, or the like of the material layer corresponding to one layer. Here, more specifically, the “material layer” is a sheet-shaped layer obtained by fusing particles by melting and pressing a physical particle layer formed based on the slice data.

A stacking control unit 204 is a processing unit that performs device control for stacking and shaping using the slice information 203 as an input and controls the above-described mechanisms described in FIG. 1. The slice data corresponding to one layer corresponds to one layer of the physical sheet-shaped material layer 111. Therefore, the shaping material 102 necessary for forming the material layer 111 based on the slice data is supplied from the shaping material supply unit 101. Moreover, the stacking control unit 204 records the number of stacked material layers and the like as stacking progress information 205 during shaping and repeatedly updates the stacking progress information 205.

A shaping object measurement unit 206 measures the height of a shaping object using the stacking thickness sensor 109 and records the measurement result (acquisition result) as shaping object measurement data 207. Here, the shaping object measurement unit 206 corresponds to an acquisition unit that acquires information on the height in the stacking direction of the material layer during shaping.

A correction unit 208 generates correction information 209 using the shaping object measurement data 207, the slice information 203, and the stacking progress information 205 as an input. The correction information 209 includes correction information calculated from information such as a theoretical value and a measurement value during shaping and the number of stacked material layers. This correction information is information related to correction of parameters used for generation of slice data, and in the present embodiment, the number of stacked material layers (the number of stacked layers) will be described as an example of the parameter as will be described later.

The slice construction unit 202 reconstructs the slice information 203 based on the correction information 209.

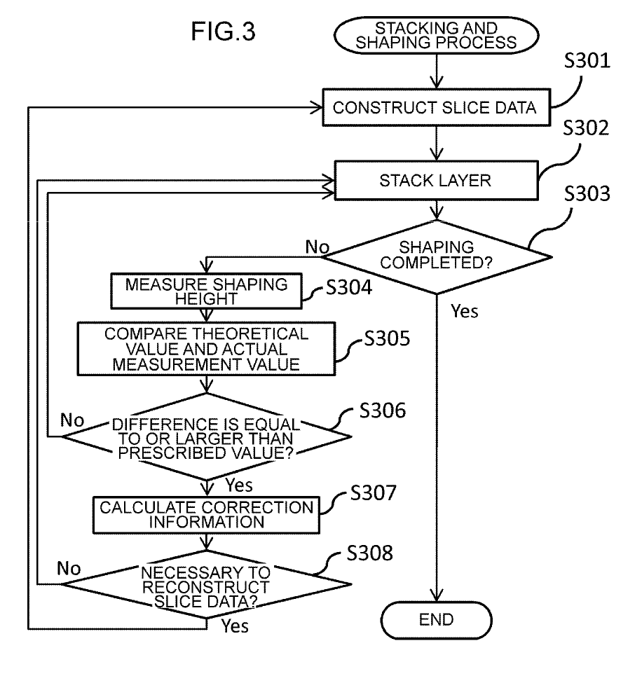

FIG. 3 illustrates a flowchart of a stacking and shaping process according to the present embodiment.

In the present embodiment, a shaping process for shaping a shaping target object having a height of 220 mm (220,000 μm) will be described.

In step S301, the slice construction unit 202 reads the shape data 201 and generates the slice information 203. In the present embodiment, a slicing process is performed so that a sliced material layer has a thickness of 22 μm. As a result, since the entire shaping target object uses 10,000 material layers, the same number of items of slice data as the number of material layers are generated. The thickness information or the like of the material layer is recorded as the slice information 203.

In step S302, the stacking control unit 204 reads the slice information 203, performs a stacking and shaping process, and stacks one layer.

In step S303, the stacking control unit 204 updates the stacking progress information 205 and determines whether a stacking process has been completed for all items of slice data on the shaping target object. When it is determined that the stacking process has been completed, the process ends. An example of the completion condition is that stacking of material layers corresponding to all items of slice data is completed. When the stacking process has not been completed, the processes of step S304 and later are performed. The processes of step S304 and later may be performed whenever one material layer is stacked and may be performed whenever a plurality of layers are stacked.

In step S304, the shaping object measurement unit 206 measures the shaping height and generates the shaping object measurement data 207. In the present embodiment, it is assumed that the measured height of the shaping object is 100 μm at a time point when five material layers are stacked.

In step S305, the correction unit 208 reads the slice information 203 and the shaping object measurement data 207 and compares a theoretical value of an expected height at that time point with an actual height value obtained by measurement. According to the material layer thickness information included in the slice information 203, the thickness of one material layer is set to 22 μm and a theoretical value at a time point when five material layers are stacked is 110 μm. It is understood that the difference is 10 μm when a difference between the theoretical value and the actual measurement value in step S304 is calculated.

In step S306, it is determined whether the difference between the theoretical value and the actual measurement value is equal to or larger than a prescribed value (set value). In the present embodiment, the prescribed value is 5 μm. The prescribed value may be determined based on the percentage % to the material layer thickness. In this case, the measurement accuracy of the stacking thickness sensor 109 may be taken into consideration. Moreover, a prescribed value in a current job may be determined based on user's setting.

When it is determined that the difference between the theoretical value and the actual measurement value is equal to or larger than the prescribed value (step S306: Yes), the flow proceeds to step S307. When it is determined that the difference is smaller than the prescribed value (step S306: No), the flow returns to step S302 and the stacking process continues.

In step S307, the correction unit 208 reads the stacking progress information 205, predicts a difference between the actual measurement value and the theoretical value, which may possibly occur in a subsequent stacking process based on the number of layers stacked up to that time point and the measurement result, and calculates the correction information 209 in which the predicted difference is taken into consideration.

In the present embodiment, since it is determined in step S306 that the difference between the theoretical value and the actual measurement value exceeds 5 μm based on the comparison result in step S305, the correction information 209 is calculated. When the correction information 209 is calculated, the total number of stacked material layers is estimated.

In the present embodiment, since the actual measurement value of the shaping height is 100 μm when the material layer corresponding to the fifth layer was stacked, the thickness of one material layer is calculated as 20 μm.

As a result, in shaping of a shaping target object having a height of 220,000 μm, the total estimated number of stacked material layers is 11,000 layers whereas the initially set total number of stacked material layers is 10,000 layers. This value is recorded as the correction information 209.

In step S308, it is determined whether it is necessary to reconstruct the slice data. In this case, in step S308, the slice construction unit 202 reads the correction information 209 and determines whether a prescribed condition to be described later is satisfied. When this prescribed condition is satisfied, it is determined that it is necessary to reconstruct the slice data (step S308: Yes), the process of step S301 is performed again, and slice data is reconstructed.

An example of the prescribed condition (that is, the condition for reconstructing the slice data) is that a difference in the total number of stacked material layers before and after estimation is equal to or larger than a prescribed value. In the present embodiment, this prescribed value is 100 layers. According to the estimation result calculated in step S307, since the difference in the total number of stacked material layers before and after estimation is 1,000 layers and exceeds the prescribed value of 100 layers, it is determined that it is necessary to reconstruct the slice data.

In the subsequent process of step S301, the slice construction unit 202 performs a process of constructing the slice data based on the shape data 201 and the correction information 209. Since the total number of stacked material layers is recorded as 11,000 layers in the correction information 209, the slice construction unit 202 divides the shaping model represented by the shape data 201 into 11,000 layers of slice data to form an image.

More specifically, the slice construction unit 202 regenerates slice data for forming a material layer necessary for completing a solid object, which is being shaped.

That is, in the present embodiment, slice data for a remaining portion of the entire shaping object excluding the stacked portion corresponding to the height of 100 μm is reconstructed. That is, the remaining shaping height 219,900 μm (=220,000 μm−100 μm) is divided by 10,995 layers (=11,000 layers−5 layers, or =219,900 μm/20 μm).

When it is determined in step S308 that it is not necessary to reconstruct the slice data, the flow returns to step S302, and the stacking process continues.

In the correction information calculation process of step S307, a method of performing correction by changing the thickness of one material layer may be used instead of changing the number of stacked material layers.

In the present embodiment, although a simple correction algorithm has been illustrated, a specific correction process is not limited to this exemplified method. The area of each material layer, the volume of a portion of the shaping object, which has been stacked or is to be stacked, the property of a material that forms the material layer, and the like can be used as information that is referenced during the correction process. For example, when the area or the volume of each material layer is referenced during the correction process, a correlation of the difference between the theoretical value and the actual measurement value of the shaping height to the area or the volume of the shaped material layer is calculated, and height correction is performed by multiplying the correlation coefficient with the area or the volume of a subsequent shaping target material layer. This is because a variation in the height occurring due to pressing or thermal shrinkage is likely to depend on the area of the material layer or the volume of the shaping object.

In measurement of the height of the shaping object in step S304, the measurement accuracy may be increased by measuring the height of a shaping object at a plurality of points using a plurality of sensors instead of controlling the measurement position according to the shape of the shaping object so that the point having the largest height is measured. Moreover, simultaneously with the stacking and shaping of the shaping target object, a measurement shaping object may be stacked on the stage 113 and the height of the measurement shaping object may be measured.

Moreover, in the present embodiment, although the stacking and shaping process of the present embodiment illustrated in FIG. 3 includes steps S306 and S308 as a determination step, the present invention is not limited to this.

For example, it may be determined in step S306 whether the difference between the theoretical value and the actual measurement value is equal to or larger than the prescribed value, and when it is determined that the difference is equal to or larger than the prescribed value, the flow returns to step S301 and the slice data may be reconstructed. In this case, the determination step of step S308 in the flowchart of FIG. 3 is not necessary.

Furthermore, step S306 may be omitted, and the correction information 209 may be calculated in step S307 without determining whether the difference between the theoretical value and the actual measurement value is equal to or larger than the prescribed value. When it is determined in step S308 that it is necessary to reconstruct the slice data based on the correction information 209, the slice data may be reconstructed in step S301.

With this configuration, the stacking and shaping process may include only one determination step and the process can be simplified.

As described above, in the present embodiment, slice data is reconstructed based on the slice information of a shaping object which has been stacked or is to be stacked and the measurement information during shaping. Due to this, it is possible to correct the height of the solid object while suppressing a decrease in the accuracy in the horizontal direction (the direction orthogonal to the stacking direction) of the shaping object as compared to the conventional example disclosed in Japanese Patent Application Publication No. 2010-240843. Therefore, it is possible to improve the shaping accuracy of the shaping target object.

### Embodiment 2

In the present embodiment, an example of reconstructing slice data based on the past correction information 209 during shaping in addition to the process of Embodiment 1 will be described. The redundant description of the same constituent elements as those of Embodiment 1 will be omitted.

The flow of a series of processes during shaping is substantially the same as that of Embodiment 1. In the present embodiment, information for specifying the shape data and the correction information 209 when shaping is performed are recorded in the control unit 200 (recording unit) in correlation as a shaping history when shaping is completed. Here, the information for specifying the shape data may be the shape data 201 itself and may be a character string such as a file name.

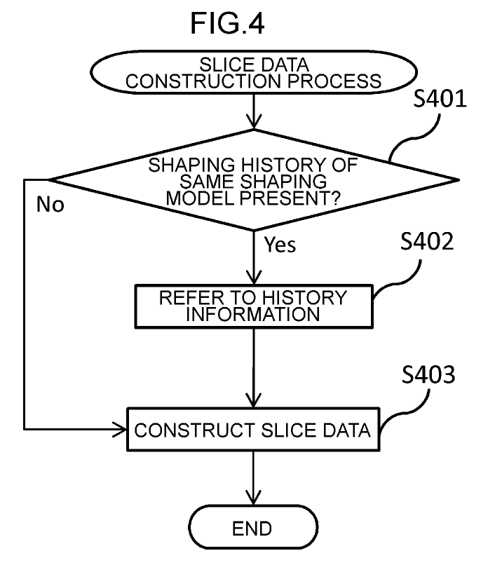

FIG. 4 illustrates a flowchart of a slice data construction process according to the present embodiment.

In step S401, the slice construction unit 202 retrieves a shaping history and determines whether the same shape data as current shape data was shaped in the past. In this determination, if only the shaping shape is identical even when all parameters are not identical, it may be determined that the shaping history is present. When the shaping history is present, the process of step S402 is performed. When the shaping history is not present, the flow proceeds to step S403.

In step S402, the slice construction unit 202 reads the correction information 209 recorded in the target shaping history detected in step S401.

In step S403, when the referenced correction information 209 is present, the slice data is constructed based on the information. For example, when it is recorded as the correction information 209 that 11,000 layers of sheet were finally used in the past shaping, a shaping object is divided into 11,000 layers in advance in current shaping to generate slice data. The subsequent process is the same as the process of step S302 and later in FIG. 3.

According to the present embodiment, since the slice construction process is performed with reference to the past shaping process result, it is possible to perform shaping with higher accuracy.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2015-251464, filed on Dec. 24, 2015, which is hereby incorporated by reference herein in its entirety.

What is claimed is:

1. A shaping apparatus including a data generation unit that generates slice data on each layer, based on given shape data, and shaping a solid object by sequentially stacking material layers formed of a shaping material, based on the slice data,
the shaping apparatus comprising:
an acquisition unit that acquires information on a height of the material layer in a stacking direction during shaping; and
a control unit that allows the data generation unit to regenerate the slice data for forming the material layer necessary for completing a solid object, which is being shaped, based on an acquisition result obtained by the acquisition unit.

2. The shaping apparatus according to claim 1, wherein
the control unit corrects a parameter used for generating the slice data in order to regenerate the slice data.

3. The shaping apparatus according to claim 2, wherein
the number of stacked layers, which is the number of stacked material layers, is used as the parameter, and
the control unit calculates the number of stacked material layers necessary for completing the solid object from the number of material layers, which have been already stacked, and the thickness of the material layer corresponding to one layer obtained from the acquisition result obtained by the acquisition unit and regenerates the slice data using the calculated number of stacked layers.

4. The shaping apparatus according to claim 1, wherein
the control unit regenerates the slice data when a difference between a theoretical value and an actual measurement value of the height of the solid object, which is being shaped, is equal to or larger than a set value, with the actual measurement value of the height of the solid object being obtained on the basis of the acquisition result obtained by the acquisition unit.

5. The shaping apparatus according to claim 1, further comprising:
a recording unit that associates information for specifying the shape data and the acquisition result obtained by the acquisition unit when shaping has been performed based on the shape data and records the same as a shaping history, wherein
the control unit allows the data generation unit to generate the slice data, based on the acquisition result recorded as the shaping history when shaping is performed based on shape data that is newly given and when determination is made that information same as the information for specifying the shape data is recorded in the recording unit as the shaping history.

6. A shaping method of using a shaping apparatus including a data generation unit that generates slice data on each layer, based on given shape data, and shaping a three-dimensional solid object by sequentially stacking material layers formed of a shaping material, based on the slice data,
the shaping method comprising:
operating an acquisition unit to acquire information on a height of the material layer in a stacking direction during shaping; and
operating the data generation unit to regenerate the slice data for forming the material layer necessary for completing a solid object, which is being shaped, based on an acquisition result obtained by the acquisition unit.

7. A non-transitory computer readable storing medium recording a computer program for allowing a computer to execute steps of a shaping method of using a shaping apparatus including a data generation unit that generates slice data on each layer, based on given shape data, and shaping a solid object by sequentially stacking material layers formed of a shaping material, based on the slice data, the steps including:
operating an acquisition unit to acquire information on a height of the material layer in a stacking direction during shaping; and
operating the data generation unit to regenerate the slice data for forming the material layer necessary for completing a solid object, which is being shaped, based on an acquisition result obtained by the acquisition unit.
